(19) United States
(12) Patent Application Publication
(10) Pub. No.: US 2026/0056488 A1
(43) Pub. Date: Feb. 26, 2026

(54) IMAGE FORMING APPARATUS

(71) Applicant: CANON KABUSHIKI KAISHA, Tokyo (JP)

(72) Inventor: SHUNTARO TEZUKA, Hanoi City (VN)

(21) Appl. No.: 19/297,839

(22) Filed: Aug. 12, 2025

(30) Foreign Application Priority Data
Aug. 26, 2024 (JP) 2024-144379

(51) Int. Cl. G03G 15/16; G03G 21/16

(52) U.S. Cl. CPC G03G 15/1685; G03G 21/168

(57) ABSTRACT

An image forming apparatus includes an apparatus body including an image bearing member, and a detachable unit detachably attached to the apparatus body. The detachable unit includes a transfer roller including a roller shaft and a pivoting member including a shaft supporting portion. The apparatus body includes a holding member configured to hold the pivoting member and including a recess. In a case where the detachable unit is attached to the apparatus body, the shaft supporting portion is allowed to enter the recess by moving the pivoting member in the first direction. The holding member is configured to hold the shaft supporting portion in a state in which the pivoting member attached to the apparatus body is pivoted to the second position and an outer peripheral surface of the shaft supporting portion comes into pressure contact with an inner surface of the recess.

### BACKGROUND

### Field of the Technology

The present disclosure relates to an image forming apparatus that forms an image on a recording material.

### Description of the Related Art

An electrophotographic image forming apparatus may include a transfer roller for transferring a toner image formed on an image bearing member such as a photosensitive drum to a recording material. Japanese Patent Laid-Open No. 2006-072395 describes a configuration in which a transfer roller and a bearing that rotatably supports a shaft of the transfer roller can be integrally replaced with respect to a printer body. According to the literature, the bearing for the transfer roller is attached to and detached from a bearing holding hook provided in the printer body.

### SUMMARY

The present disclosure provides an image forming apparatus in which positioning accuracy for a transfer roller can be improved without impairing workability of replacement.

An aspect of the disclosure provides an image forming apparatus including an apparatus body including an image bearing member, and a detachable unit detachably attached to the apparatus body, the detachable unit including (i) a transfer roller including a roller shaft configured to rotate around a rotation axis, the transfer roller being configured to form a transfer portion, at which an image is transferred from the image bearing member to a recording material, together with the image bearing member, and (ii) a pivoting member including a shaft supporting portion supporting the roller shaft rotatably, the pivoting member being pivotable between a first position and a second position around the rotation axis in a state in which the detachable unit is attached to the apparatus body, wherein the apparatus body includes a holding member configured to hold the pivoting member and including a recess recessed in a first direction intersecting the rotation axis, wherein in a case where the detachable unit is attached to the apparatus body, the shaft supporting portion is allowed to enter the recess by moving the pivoting member in the first direction while maintaining the pivoting member in a posture corresponding to a posture of the pivoting member when the pivoting member attached to the apparatus body is at the first position, wherein the holding member is configured to hold the shaft supporting portion in a state in which the pivoting member attached to the apparatus body is pivoted to the second position and an outer peripheral surface of the shaft supporting portion comes into pressure contact with an inner surface of the recess, and wherein a first length is smaller than a second length, the first length being a width of the outer peripheral surface of the shaft supporting portion in a second direction orthogonal to the first direction in a case where the pivoting member at the first position is viewed in a direction of the rotation axis, the second length being a width of the outer peripheral surface in the second direction in a case where the pivoting member at the second position is viewed in the direction of the rotation axis.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an image forming apparatus according to an embodiment.

FIG. 2A is a perspective view of a transfer roller unit and a photosensitive drum according to a first embodiment.

FIG. 2B is a cross-sectional view of the transfer roller unit and the photosensitive drum according to the first embodiment.

FIG. 3 is an explanatory view relating to attachment and detachment of the transfer roller unit according to the first embodiment.

FIG. 4 is a perspective view of the transfer roller unit according to the first embodiment.

FIG. 5A is a side view of a shaft-receiving member according to the first embodiment.

FIG. 5B is a perspective view of the shaft-receiving member according to the first embodiment.

FIG. 6A is a side view of a holding member according to the first embodiment.

FIG. 6B is a perspective view of the holding member according to the first embodiment.

FIG. 7A is an explanatory view relating to attachment of the shaft-receiving member on the holding member according to the first embodiment.

FIG. 7B is an explanatory view relating to attachment of the shaft-receiving member on the holding member according to the first embodiment.

FIG. 7C is an explanatory view relating to attachment of the shaft-receiving member on the holding member according to the first embodiment.

FIG. 8 is an explanatory view of the shaft-receiving member and the holding member according to the first embodiment.

FIG. 9 is an explanatory view relating to attachment and detachment of a transfer roller unit according to a second embodiment.

FIG. 10 is a perspective view of the transfer roller unit according to the second embodiment.

FIG. 11 is a side view of a shaft-receiving member according to a third embodiment.

FIG. 12 is a side view of a holding member according to the third embodiment.

FIG. 13A is an explanatory view relating to attachment of the shaft-receiving member on the holding member according to the third embodiment.

FIG. 13B is an explanatory view relating to attachment of the shaft-receiving member on the holding member according to the third embodiment.

FIG. 13C is an explanatory view relating to attachment of the shaft-receiving member on the holding member according to the third embodiment.

### DESCRIPTION OF THE EMBODIMENTS

Hereinafter, embodiments according to the present disclosure will be described with reference to the drawings.

### First Embodiment

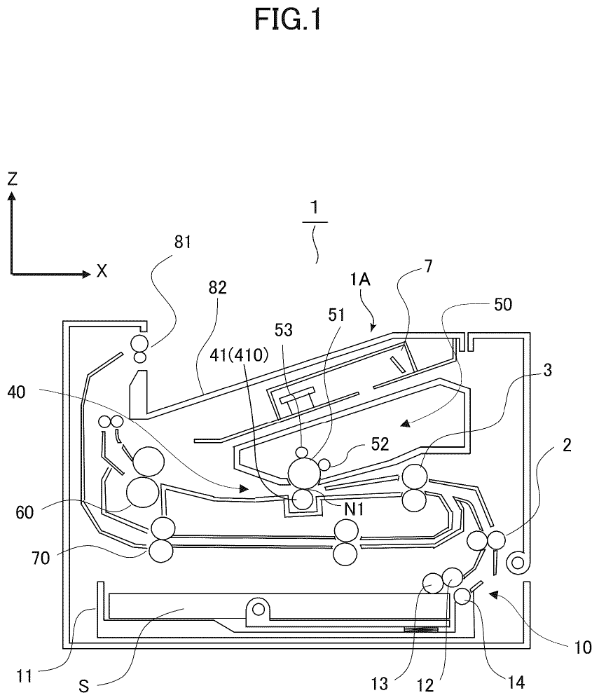

FIG. 1 is a schematic view illustrating a cross section of a printer 1 that is an image forming apparatus according to an embodiment (first embodiment) of the present disclosure.

In the following description and drawings, a vertical direction (gravity direction) when the printer 1 is installed on a horizontal plane is referred to as a Z-axis direction. A direction of a rotation axis of a photosensitive drum 51 (image bearing member) included in the printer 1 is referred to as a Y-axis direction. A direction intersecting both the Z-axis direction and the Y-axis direction is referred to as an X-axis direction. The X-axis direction, the Y-axis direction, and the Z-axis direction are preferably orthogonal to each other.

First, an outline of the printer 1 will be described. The printer 1 is an electrophotographic laser beam printer that forms a monochrome image. As illustrated in FIG. 1, the printer 1 includes a sheet feeding unit 10, a conveyance roller pair 2, a registration roller pair 3, an image forming unit 40, a fixing device 60, a duplex printing conveyance portion 70, a discharge roller pair 81, and a discharge tray 82.

The image forming unit 40 includes a process unit 50, an exposure device 7, and a transfer roller 41. The process unit 50 includes the photosensitive drum 51 serving as an image bearing member that bears a toner image and a latent image, a charging roller 52 serving as a charger, a developing unit including a developing roller 53, and a cleaning unit. The photosensitive drum 51 is a columnar (drum-shaped) member in which a photosensitive layer is formed of an organic photosensitive material or the like on a surface of a metal substrate. A toner serving as a developer is stored in the developing unit. The process unit 50 is implemented as a cartridge that is attachable to and detachable from (replaceable with respect to) an apparatus body 1A of the printer 1.

The transfer roller 41 forms a transfer nip N1 serving as a transfer portion with the photosensitive drum 51. As described in detail below, the transfer roller 41 of the present embodiment is attachable to and detachable from (replaceable with respect to) the apparatus body 1A as a part of a transfer roller unit 410. The apparatus body 1A in the present embodiment refers to a portion of the printer 1 excluding the process unit 50 and the transfer roller unit 410.

In the present embodiment, the transfer roller 41 is disposed below the photosensitive drum 51. The exposure device 7 is disposed above the process unit 50, and the duplex printing conveyance portion 70 is positioned so as to pass below the transfer roller 41. The exposure device 7 includes a laser light source and an exposure optical system that guides light emitted from the laser light source to the photosensitive drum 51. The exposure device 7 may be a light emitting diode (LED) exposure device including a plurality of LED light sources arranged in a rotation axis direction of the photosensitive drum 51.

The fixing device 60 is a thermal fixing unit that includes a pair of rotating members forming a fixing nip and heats the toner image on a sheet S at the fixing nip. The fixing device 60 includes a fixing member, a heat source that heats the fixing member, and a pressing member that forms the fixing nip together with the fixing member. The fixing member may be any one of a cylindrical roller, a tubular flexible film, and a belt stretched around a plurality of rollers. As the heat source, for example, a halogen lamp that generates radiant heat, a heater substrate on which a pattern of a resistance heating element is printed on a ceramic substrate, or a coil unit that causes a conductive layer in the fixing member to generate heat by induction heating can be used.

The sheet feeding unit 10 includes a cassette 11 in which the sheet S is stacked and stored, and a feeding unit that feeds the sheet S from the cassette 11. As the sheet S serving as the recording material (recording medium), various sheet materials having different sizes and materials, such as paper such as plain paper or thick paper, a sheet material subjected to surface treatment such as coated paper, a sheet material having a special shape such as an envelope or index paper, a plastic film, and cloth, can be used.

A lift plate (middle plate) that can be lifted and lowered in a state of supporting the sheet S is disposed in the cassette 11. The feeding unit of the present embodiment includes a pickup roller 13, a feed roller 12, and a retard roller 14. The retard roller 14 is a roller to which a driving force (retard driving) in a direction opposite to a sheet feeding direction is input via a torque limiter. The retard roller 14 is an example of a separation member that forms a separation nip with the feed roller 12 and separates the sheet S by a frictional force. As the separation member, for example, a pad-shaped elastic member (separation pad) may be used.

A series of operations (image forming operations) in which the printer 1 forms an image on the sheet S while conveying the sheets S one by one will be described. When an image formation instruction (printing instruction) is input from an external computer or the like connected to the printer 1, a control unit of the printer 1 starts the image forming operation.

The control unit starts an electrophotographic process using the image forming unit 40 based on image information input from an external computer or the like. Specifically, the charging roller 52 uniformly charges a surface of the rotating photosensitive drum 51. The exposure device 7 irradiates the photosensitive drum 51 with laser light based on the input image information. As a result, the photosensitive drum 51 is exposed, and an electrostatic latent image is formed on the surface of the photosensitive drum 51. The developing unit causes the developing roller 53 to bear the toner and supplies the toner to the photosensitive drum 51, thereby developing the electrostatic latent image into the toner image.

In parallel with the operation of the image forming unit 40 described above, the sheet S stored in the cassette 11 of the sheet feeding unit 10 is fed by the pickup roller 13. The sheets S fed by the pickup roller 13 are separated one by one by the feed roller 12 and the retard roller 14, and are conveyed to the registration roller pair 3 via the conveyance roller pair 2. After performing skew feeding correction for the sheet S, the registration roller pair 3 conveys the sheet S to the transfer nip N1 according to a timing of the toner image formed on the photosensitive drum 51 in the image forming unit 40.

As a transfer bias (transfer voltage) is applied to the transfer roller 41, the toner image is transferred from the photosensitive drum 51 to the sheet S when the sheet S passes through the transfer nip N1. The remaining toner that remains on the photosensitive drum 51 without being transferred to the sheet S is collected by the cleaning unit of the process unit 50.

The sheet S having passed through the transfer nip N1 is subjected to image fixing processing through heating and pressing performed by the fixing device 60. The sheet S having passed through the fixing device 60 is discharged to the outside of the apparatus body by the discharge roller pair 81 (discharge portion), and is stacked on the discharge tray 82. In the case of duplex printing in which images are formed on both surfaces of the sheet S, the sheet S having a first surface on which the image is formed by passing through the transfer nip N1 and the fixing device 60 is reversed by the discharge roller pair 81 (reverse portion) and conveyed again toward the transfer nip N1 via the duplex printing conveyance portion 70. Then, the sheet S having a second surface on which the image is formed by passing through the transfer nip N1 and the fixing device 60 again is discharged to the outside of the apparatus body by the discharge roller pair 81 and is stacked on the discharge tray 82.

### Transfer Roller Unit

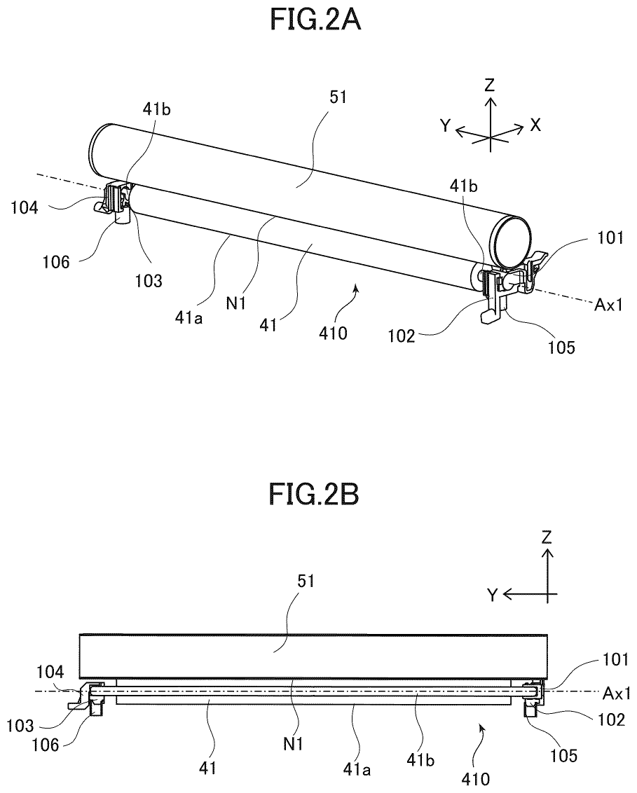

The transfer roller unit 410 will be described with reference to FIGS. 2A and 2B. FIG. 2A is a perspective view of the photosensitive drum 51 and the transfer roller unit 410. FIG. 2B is a cross-sectional view of the photosensitive drum 51 and the transfer roller unit 410 on a plane passing through the rotation axis of the photosensitive drum 51 and a rotation axis Ax1 of the transfer roller 41. FIGS. 2A and 2B illustrate a state in which both the process unit 50 and the transfer roller unit 410 are attached to the apparatus body 1A.

As illustrated in FIGS. 2A and 2B, the transfer roller unit 410 includes the transfer roller 41 and a shaft-receiving member 101. The transfer roller unit 410 is a detachable unit (replaceable unit) that is attachable to and detachable from (replaceable with respect to) the apparatus body 1A.

The transfer roller 41 includes a roller body 41a having an outer peripheral surface that can come into contact with an outer peripheral surface of the photosensitive drum 51, and a rotation shaft 41b (shaft portion, roller shaft) that supports the roller body 41a. The transfer roller 41 is rotatable about the rotation axis Ax1 passing through the center of the rotation shaft 41b. In a state in which both the process unit 50 and the transfer roller unit 410 are attached to the apparatus body 1A, the rotation axis Ax1 is parallel to the rotation axis of the photosensitive drum 51. Hereinafter, a direction of the rotation axis Ax1 of the transfer roller 41 may be referred to as a “roller axis direction”.

One end of the rotation shaft 41b of the transfer roller 41 is rotatably supported (held) by the shaft-receiving member 101 which is a first shaft-receiving member or first bearing. The other end of the rotation shaft 41b of the transfer roller 41 is rotatably supported (held) by a shaft-receiving member 103 which is a second shaft-receiving member or second bearing.

In the present embodiment, the shaft-receiving member 103 is disposed in the apparatus body 1A. That is, even in a case where the transfer roller unit 410 is removed from the apparatus body 1A when replacing the transfer roller 41, the shaft-receiving member 103 remains in the apparatus body 1A. However, the shaft-receiving member 103 may also be a part of the transfer roller unit 410.

A holding member 102 and a nip pressure spring 105 corresponding to the shaft-receiving member 101, and a holding member 104 and a nip pressure spring 106 corresponding to the shaft-receiving member 103 are disposed in the apparatus body 1A. The holding members 102 and 104 (support members) are engaged with and hold (support) the shaft-receiving members 101 and 103, respectively.

Each of the holding members 102 and 104 is configured to be slidable (linearly movable or reciprocally movable) in an up-down direction (Z-axis direction) in FIG. 2B with respect to a frame body of the apparatus body 1A. The nip pressure springs 105 and 106 are urging members that urge the holding members 102 and 104 upward in FIG. 2B, respectively. Urging forces of the nip pressure springs 105 and 106 are transmitted to the transfer roller 41 via the holding members 102 and 104 and the shaft-receiving members 101 and 103, respectively. Directions of the urging forces applied to the holding members 102 and 104 by the nip pressure springs 105 and 106 are directions from the rotation axis Ax1 of the transfer roller 41 to the rotation axis of the photosensitive drum 51. Therefore, in a state in which both the process unit 50 and the transfer roller unit 410 are attached to the apparatus body 1A, the transfer roller 41 is pressed against the photosensitive drum 51 by the urging forces of the nip pressure springs 105 and 106, and the transfer nip N1 is formed.

The transfer roller 41 is electrically connected to a high-voltage substrate disposed in the apparatus body 1A, and is configured to receive the transfer voltage from a voltage application circuit on the high-voltage substrate. At least the nip pressure spring and the shaft-receiving member (the nip pressure spring 106 and the shaft-receiving member 103 in the present embodiment) on one side are conductive members, and form a path for applying the transfer voltage to the transfer roller 41.

The shaft-receiving member 103 and the holding member 104 of the present embodiment may be implemented by an integral member. In this case, the integral member rotatably supports the rotation shaft 41b of the transfer roller 41 and receives the urging force of the nip pressure spring 106. The integral member may be disposed in the apparatus body 1A similarly to the holding member 104 and the shaft-receiving member 103 of the present embodiment, or may be disposed in the transfer roller unit 410.

### Transfer Roller Replacement Work

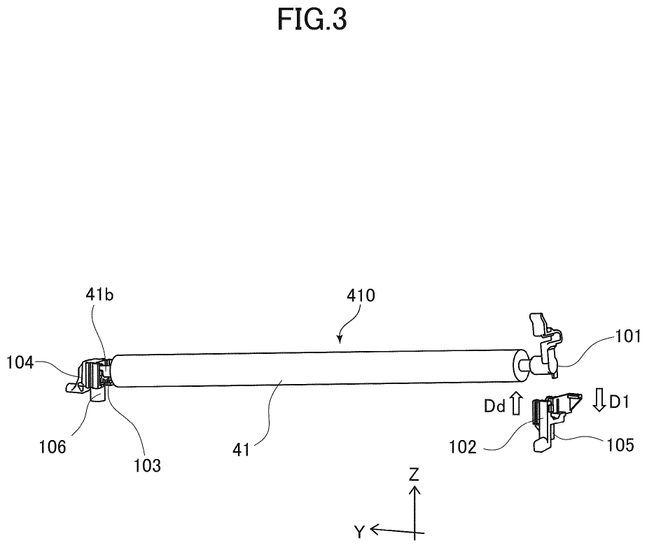

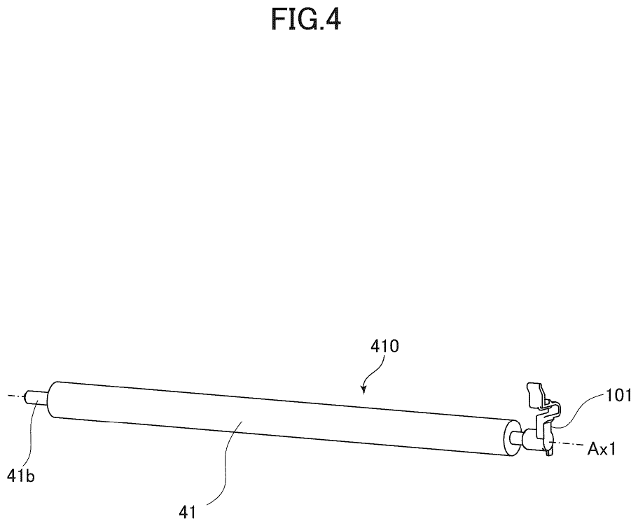

A replacement work for the transfer roller 41 will be described. FIG. 3 is a perspective view illustrating a state in which the transfer roller unit 410 is being detached from the apparatus body 1A. FIG. 4 is a perspective view illustrating the transfer roller unit 410 in a state of being detached from the apparatus body 1A.

As illustrated in FIG. 3, in the case of replacing the transfer roller 41 in the present embodiment, the transfer roller 41 and the shaft-receiving member 101 on one side are integrally removed from the apparatus body 1A as the transfer roller unit 410. The shaft-receiving member 101 is detached from the holding member 102 of the apparatus body 1A in a detaching direction Dd. The detaching direction Dd is a direction intersecting (preferably, orthogonal to) a roller axial direction (Y-axis direction) of the transfer roller 41 in a state in which the transfer roller unit 410 is attached to the apparatus body 1A.

When the transfer roller unit 410 is moved along the rotation axis Ax1 after the shaft-receiving member 101 is detached from the holding member 102, the rotation shaft 41b is pulled out from the shaft-receiving member 103 remaining in the apparatus body 1A. Accordingly, the removal of the transfer roller unit 410 from the apparatus body 1A is completed. The removed transfer roller unit 410 may be replaced with a new transfer roller unit 410, or the removed transfer roller unit 410 may be further disassembled to replace only the transfer roller 41.

In the case of attaching the transfer roller unit 410 on the apparatus body 1A, after the rotation shaft 41b is engaged with the shaft-receiving member 103, the shaft-receiving member 101 is moved in an attaching direction D1 opposite to the detaching direction Dd and attached to the holding member 102. Details of the attaching of the shaft-receiving member 101 are described below.

With a configuration in which the shaft-receiving member 101 and the transfer roller 41 are attached to and detached from the apparatus body 1A as an integral unit, it is possible to prevent a finger or the like of an operator from touching a surface of the transfer roller 41 when replacing the transfer roller 41.

With the configuration of the present embodiment, even in a case where the transfer roller unit 410 is removed from the apparatus body 1A, at least the holding members 102 and 104 and the nip pressure springs 105 and 106 remain in the apparatus body 1A. Therefore, in the replacement work for the transfer roller 41, the transfer roller unit 410 is less likely to receive the urging forces of the nip pressure springs 105 and 106, and workability can be improved.

In addition, some printers 1 may include a separation mechanism capable of separating the transfer roller 41 from the photosensitive drum 51 in a state in which the transfer roller unit 410 is attached to the apparatus body 1A. The separation mechanism is, for example, a mechanism that moves the holding members 102 and 104 against the urging forces of the nip pressure springs 105 and 106. Even in the case of the printer 1 including the separation mechanism, with the configuration of the present embodiment, the transfer roller unit 410 can be removed from the apparatus body 1A while the holding members 102 and 104 remain in the apparatus body 1A. That is, the transfer roller 41 can be replaced in a state in which the separation mechanism and the holding members 102 and 104 separate the transfer roller 41 from the photosensitive drum 51.

### Attaching Configuration for Shaft-Receiving Member

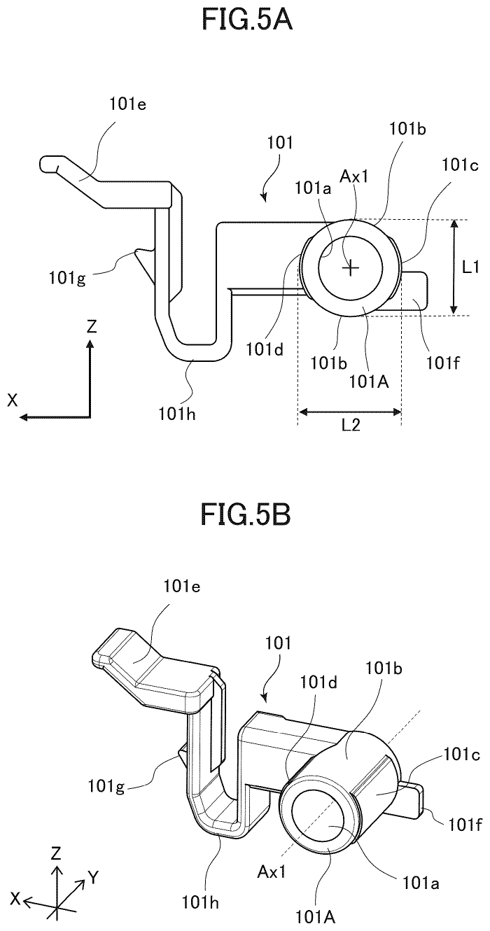

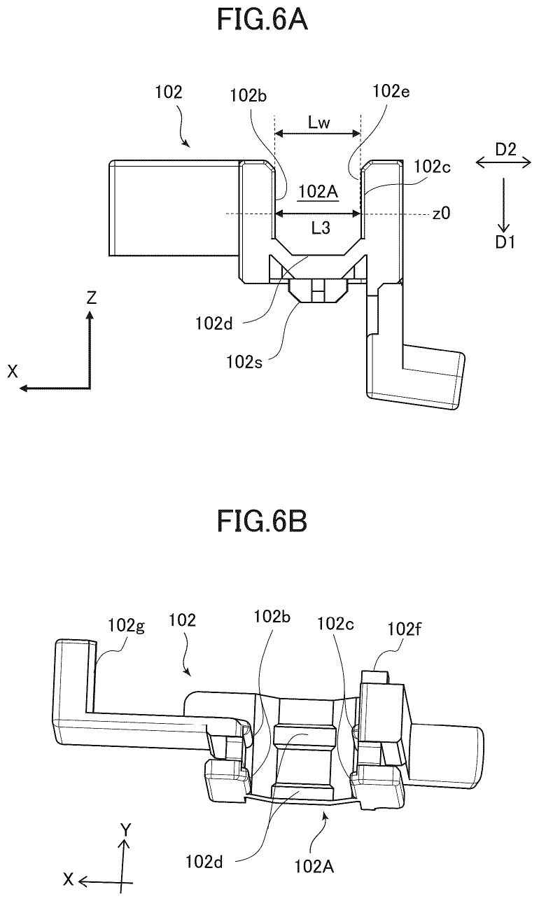

Next, a configuration relating to the attachment of the shaft-receiving member 101 and the holding member 102 will be described. FIG. 5A is a side view of the shaft-receiving member 101 as viewed in the direction (Y-axis direction) of the rotation axis Ax1 of the transfer roller 41. FIG. 5B is a perspective view of the shaft-receiving member 101. FIG. 6A is a side view of the holding member 102 as viewed in the Y-axis direction. FIG. 6B is a perspective view of the holding member 102 as viewed from above. FIGS. 5A and 5B illustrate the shaft-receiving member 101 in a state of being at a second position described below.

As illustrated in FIGS. 5A and 5B, the shaft-receiving member 101 includes a shaft supporting portion 101A, an operation portion 101e, a retaining rib 101f, a claw portion 101g, and an arm portion 101h. The shaft-receiving member 101 may be an integral component in which the above-described portions are continuously formed using a resin material.

The shaft supporting portion 101A is a tubular portion in which a supporting surface 101a that rotatably supports the rotation shaft 41b of the transfer roller 41 is provided on an inner peripheral side. The shaft supporting portion 101A is engaged with a recess 102A of the holding member 102 described below.

An outer peripheral surface of the shaft supporting portion 101A includes an arcuate portion 101b (cylindrical portion) formed in an arcuate shape (cylindrical surface shape) as viewed in the roller axial direction, and protrusions 101c and 101d protruding outward from the arcuate portion 101b in a radial direction orthogonal to the rotation axis Ax1. In the present embodiment, the protrusions 101c and 101d are provided at two positions opposite to each other across the rotation axis Ax1. However, the protrusion 101c or 101d may be provided only on one side of the rotation axis Ax1.

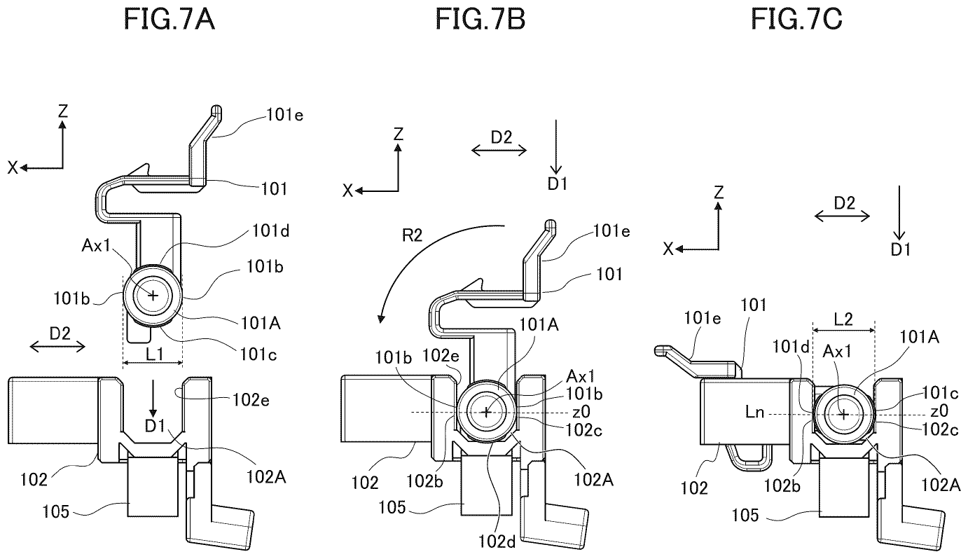

The shaft-receiving member 101 is rotatable (movable) to a first position (FIGS. 7A and 7B) and a second position (FIGS. 5A and 7C) around the rotation axis Ax1. That is, the shaft-receiving member 101 is a pivoting member pivotable around the rotation axis Ax1. As the shaft-receiving member 101 pivots, orientations of the protrusions 101c and 101d are changed, and a width of the shaft supporting portion 101A in a width direction D2 of the recess 102A is changed. The width direction D2 (second direction) of the recess 102A is a direction orthogonal to the attaching direction D1 (first direction) of the shaft-receiving member 101 with respect to the holding member 102 as viewed in the roller axis direction.

A width of the outer peripheral surface of the shaft supporting portion 101A in the width direction D2 when the shaft-receiving member 101 is at the first position (a first phase, a first angle, or an attachment/detachment posture) is referred to as L1 (first length). A width of the outer peripheral surface of the shaft supporting portion 101A in the width direction D2 when the shaft-receiving member 101 is pivoted from the first position to the second position (a second phase, a second angle, or an attaching posture) is referred to as L2 (second length).

In the present embodiment, L2 is larger than L1 (L2>L1). In other words, the width of the outer peripheral surface of the shaft supporting portion 101A in the width direction D2 (second direction) when the shaft supporting portion 101A is engaged with the recess 102A in a state in which the shaft-receiving member 101 is at the first position is referred to as the first length (L1). The width of the outer peripheral surface of the shaft supporting portion 101A in the width direction D2 (second direction) when the shaft-receiving member 101 is pivoted from the first position to the second position (the second phase, the second angle, or the attaching posture) in a state in which the shaft supporting portion 101A is engaged with the recess 102A is referred to as the second length (L2). In this case, the first length is smaller than the second length.

Specifically, in the present embodiment, the protrusions 101c and 101d are disposed such that the arcuate portion 101b is directed to the width direction D2 when the shaft-receiving member 101 is at the first position, and the protrusions 101c and 101d are directed to the width direction D2 when the shaft-receiving member 101 is at the second position. Therefore, L1 in the present embodiment is a diameter of the arcuate portion 101b. L2 in the present embodiment is equal to a value obtained by adding a protruding amount of each of the protrusions 101c and 101d from the arcuate portion 101b to the diameter of the arcuate portion 101b. That is, the width L2 of the shaft supporting portion 101A when the shaft-receiving member 101 is at the second position is larger than the width L1 of the shaft supporting portion 101A when the shaft-receiving member 101 is at the first position, by the protruding amounts of the protrusions 101c and 101d.

The operation portion 101e (grip portion) is a lever-shaped portion operated (gripped) to move the shaft-receiving member 101 between the first position and the second position. When viewed in the roller axial direction, the operation portion 101e protrudes to the outside of the shaft supporting portion 101A, and is connected to the shaft supporting portion 101A via the arm portion 101h.

In the present embodiment, the operation portion 101e is disposed as a part of the shaft-receiving member 101, but the operation portion 101e may be a member disposed separately from the shaft-receiving member 101. In this case, the operation portion 101e and the shaft-receiving member 101 are coupled using a link, a cam, or the like such that the shaft-receiving member 101 moves in conjunction with the operation portion 101e by the operation of the operation portion 101e.

The claw portion 101g is formed so as to protrude from the arm portion 101h (FIGS. 5A and 5B). At least a part of the arm portion 101h is formed as a thin portion that can be elastically deformed (deflected) so as to enable movement of the operation portion 101e and the claw portion 101g.

The retaining rib 101f protrudes outward from the outer peripheral surface of the shaft supporting portion 101A as viewed in the roller axial direction (FIGS. 5A and 5B).

As illustrated in FIGS. 6A and 6B, the holding member 102 includes the recess 102A, a contacting portion 102f, a locking portion 102g, and a spring receiving portion 102s. The holding member 102 may be an integral part in which the above-described portions are continuously formed using a resin material.

The recess 102A has a recessed shape (groove shape) recessed in the attaching direction D1. The recess 102A of the present embodiment is formed to have side surfaces 102b and 102c facing each other in the width direction D2, and a bottom surface 102d connecting downstream ends (lower ends) of the side surfaces 102b and 102c in the attaching direction D1. In the present embodiment, each of the side surfaces 102b and 102c is formed using a rib extending in the attaching direction D1, and the bottom surface 102d is formed using a rib extending in the width direction D2 (FIG. 6B). An upstream portion of the recess 102A in the attaching direction D1 is referred to as an opening 102e.

In a state in which the shaft-receiving member 101 is not engaged with the holding member 102, an interval between the side surfaces 102b and 102c of the recess 102A at a reference position z0 in the attaching direction D1 is referred to as a width L3 of the recess 102A. The reference position z0 is a position in the recess 102A where the rotation axis Ax1 of the transfer roller 41 is positioned when the shaft-receiving member 101 is engaged with the holding member 102 (FIG. 7C). In the present embodiment, the reference position z0 is a position of the rotation axis Ax1 in a state in which the outer peripheral surface of the shaft supporting portion 101A comes into contact with the bottom surface 102d of the recess 102A. In the following description, a position of the shaft supporting portion 101A when the rotation axis Ax1 is at the reference position z0 may also be referred to as the reference position z0 of the shaft supporting portion 101A.

In a state in which the shaft-receiving member 101 is not engaged with the holding member 102, a minimum value of the interval between the side surfaces 102b and 102c of the recess 102A within an area upstream of the reference position z0 in the attaching direction D1 is referred to as an opening width Lw of the recess 102A. In the present embodiment, ridge portions of the ribs forming the side surfaces 102b and 102c are both linear and parallel to each other. Therefore, the opening width Lw of the recess 102A in the present embodiment is equal to the width L3 of the recess 102A at the reference position z0.

The width L3 of the recess 102A of the holding member 102 at the reference position z0 is larger than the width L1 of the shaft supporting portion 101A when the shaft-receiving member 101 is at the first position, and is smaller than the width L2 of the shaft supporting portion 101A when the shaft-receiving member 101 is at the second position. That is, L2>L3>L1. Advantages of such a configuration are described below.

The spring receiving portion 102s supports the nip pressure spring 105 (see FIG. 7C) and receives the urging force of the nip pressure spring 105. The spring receiving portion 102s is provided on a back side of the bottom surface 102d of the recess 102A in the attaching direction D1.

The locking portion 102g is disposed at a position engageable with the operation portion 101e and the claw portion 101g of the shaft-receiving member 101. The contacting portion 102f is disposed at a position engageable with the retaining rib 101f of the shaft-receiving member 101.

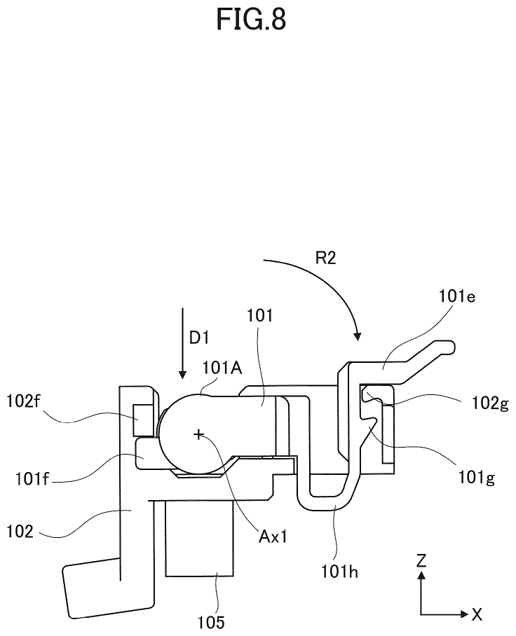

The attachment of the shaft-receiving member 101 on the holding member 102 will be described with reference to FIGS. 7A to 7C and 8. FIGS. 7A to 7C are views of the shaft-receiving member 101 and the holding member 102 as viewed from the inside of the apparatus (a center side of the transfer roller 41) in the roller axial direction. FIG. 7A illustrates a state before the shaft-receiving member 101 is attached to the holding member 102. FIG. 7B illustrates a state in which the shaft-receiving member 101 is at the first position and the shaft supporting portion 101A is engaged with the recess 102A of the holding member 102. FIG. 7C further illustrates a state in which the shaft-receiving member 101 is pivoted from the first position to the second position.

As illustrated in FIG. 7A, in a case where the transfer roller unit 410 is attached to the apparatus body 1A, the shaft-receiving member 101 is moved in the attaching direction D1 while maintaining the shaft-receiving member 101 in a posture corresponding to a posture thereof when the shaft-receiving member 101 attached to the apparatus body is at the first position. As a result, the shaft supporting portion 101A of the shaft-receiving member 101 passes through the opening 102e of the holding member 102 that is opened toward an upstream side in the attaching direction D1 and is engaged with the recess 102A.

As described above, the width L1 of the shaft supporting portion 101A when the shaft-receiving member 101 is at the first position is smaller than the opening width Lw of the recess 102A of the holding member 102 (L1<Lw). In other words, in a state in which the transfer roller unit 410 (detachable unit) is not attached to the apparatus body 1A, the minimum value of the width of the recess 102A in the width direction D2 (second direction) within an area upstream of the reference position z0 in the attaching direction D1 (first direction) is referred to as the opening width Lw of the recess 102A. In this case, the first length (L1) is smaller than the opening width (Lw) of the recess 102A.

Therefore, the shaft supporting portion 101A is received in the recess 102A without receiving a frictional resistance due to rubbing with an inner surface of the recess 102A. Specifically, the shaft supporting portion 101A passes through the opening 102e of the recess 102A in a state in which there is a gap between the arcuate portion 101b of the shaft supporting portion 101A and the side surfaces 102b and 102c of the recess 102A. When an outer surface of the shaft supporting portion 101A comes into contact with the bottom surface 102d of the recess 102A, the shaft supporting portion 101A reaches the reference position z0.

As illustrated in FIG. 7B, in a state in which the shaft supporting portion 101A has reached the reference position z0, the operator operates the operation portion 101e to pivot the shaft-receiving member 101 in a pivoting direction R2 from the first position to the second position. Then, the protrusions 101c and 101d of the outer peripheral surface of the shaft supporting portion 101A face the side surfaces 102c and 102b of the recess 102A, respectively. When the shaft-receiving member 101 is pivoted from the first position to the second position in a state in which the shaft supporting portion 101A is at the reference position z0, the attaching of the shaft-receiving member 101 to the holding member 102 is completed.

As described above, the width L2 of the shaft supporting portion 101A when the shaft-receiving member 101 is at the second position is larger than the width L3 of the recess 102A of the holding member 102 (L2>L3). Therefore, as the shaft-receiving member 101 is pivoted to the second position, a part (protrusions 101c and 101d) of the outer peripheral surface of the shaft supporting portion 101A comes into pressure contact with the inner surface of the recess 102A (press-fitted state). As a result, the movement of the shaft supporting portion 101A in the width direction D2 is restricted, and a rotation axis of the transfer roller 41 is positioned in the width direction D2.

As described above, the outer peripheral surface of the shaft supporting portion 101A comes into pressure contact with the inner surface of the recess 102A, so that play of the shaft-receiving member 101 can be suppressed, and deterioration in positioning accuracy for the transfer roller 41 can be suppressed. For example, even when there is a variation in a dimension of the shaft supporting portion 101A or a dimension of the recess 102A due to manufacturing tolerance of the shaft-receiving member 101 or the holding member 102, such a variation is unlikely to appear as the deterioration in positioning accuracy for the transfer roller 41. Then, since the deterioration in positioning accuracy for the transfer roller 41 is suppressed, it is possible to transfer an image under favorable conditions at the transfer nip N1, which contributes to improvement of image quality.

In the present embodiment, in a state in which the shaft-receiving member 101 is at the second position, at least a part of the protrusions 101c and 101d of the shaft supporting portion 101A is directed to a recording material conveyance direction at the transfer nip N1. In other words, as viewed in the roller axis direction in a state in which the shaft-receiving member 101 is at the second position, a contact region of the outer peripheral surface of the shaft supporting portion 101A that comes into contact with the inner surface of the recess 102A intersects an imaginary straight line Ln (FIG. 7C) extending in the recording material conveyance direction through the rotation axis Ax1. In this case, a pressure contact force generated between the outer peripheral surface of the shaft supporting portion 101A and the inner surface of the recess 102A is in a direction (preferably, a parallel direction) along the recording material conveyance direction. Therefore, even in a case where a force directed upstream or downstream in the recording material conveyance direction is applied to the transfer roller 41 from the sheet S passing through the transfer nip N1, it is possible to suppress a positional fluctuation of the shaft supporting portion 101A in the recording material conveyance direction and suppress an influence on the transfer.

In the present embodiment, the recess 102A of the holding member 102 is opened toward an urging direction of the nip pressure spring 105. Therefore, it is possible to prevent the urging force of the nip pressure spring 105 from causing deformation of the holding member 102 that affects positioning accuracy for the shaft supporting portion 101A (for example, deformation that increases the width L3 of the recess 102A).

In the present embodiment, the recess 102A of the holding member 102 is formed in a U shape, and the shaft supporting portion 101A of the shaft-receiving member 101 is formed in a substantially cylindrical shape as viewed in the roller axial direction. Therefore, the recess 102A of the holding member 102 has a shape that is more easily elastically deformed than the shaft supporting portion 101A. In addition, the holding member 102 is preferably formed of an elastically deformable material such that a deformation amount of the inner surface of the recess 102A due to the engagement with the shaft supporting portion 101A is larger than a deformation amount of the outer peripheral surface of the shaft supporting portion 101A due to the engagement with the recess 102A. As a result, it is possible to suppress the deformation of the shaft supporting portion 101A due to the engagement with the recess 102A, and it is possible to suppress a decrease in slidability between the rotation shaft 41b of the transfer roller 41 and the shaft supporting portion 101A.

A relationship between the shaft-receiving member 101 and the holding member 102 in a state in which the shaft-receiving member 101 is held by the holding member 102 will be further described with reference to FIG. 8. FIG. 8 is a view of the shaft-receiving member 101 and the holding member 102 of FIG. 7C as viewed from the outside of the apparatus (a side opposite to that illustrated in FIG. 7C) in the roller axial direction.

As illustrated in FIG. 8, the operation portion 101e of the shaft-receiving member 101 is provided at a position farther outward than the protrusions 101c and 101d of the shaft supporting portion 101A in the radial direction orthogonal to the rotation axis Ax1 of the transfer roller 41. Therefore, it is possible to reduce an operation force applied to the operation portion 101e when the shaft-receiving member 101 is pivoted from the first position to the second position against a resistance caused by the pressure contact between the protrusions 101c and 101d and the inner surface of the recess 102A.

In the present embodiment, a protruding direction of the operation portion 101e with respect to the shaft supporting portion 101A is a direction along a protruding direction of the protrusions 101c and 101d. Therefore, when the operator grips the operation portion 101e before attaching the shaft-receiving member 101 on the holding member 102, the shaft-receiving member 101 is naturally positioned at the first position (FIG. 7A) due to an own weight of the transfer roller unit 410, so that the attaching operation can be smoothly performed.

As illustrated in FIG. 8, when the shaft-receiving member 101 is pivoted to the second position in a state in which the shaft supporting portion 101A has reached the reference position z0, the retaining rib 101f of the shaft-receiving member 101 comes into contact with the contacting portion 102f of the holding member 102. In this case, the retaining rib 101f is positioned downstream of the contacting portion 102f in the attaching direction D1, and the separation of the shaft supporting portion 101A from the recess 102A is restricted by the contacting portion 102f. In a state in which the shaft-receiving member 101 is at the first position, the shaft supporting portion 101A is allowed to enter (i.e., to be engaged with) the recess 102A without interference between the retaining rib 101f and the contacting portion 102f.

On the other hand, when the shaft-receiving member 101 is pivoted to the second position in a state in which the shaft supporting portion 101A has not reached the reference position z0, the engagement of the shaft supporting portion 101A with the recess 102A is hindered by the interference between the retaining rib 101f and the contacting portion 102f. In this case, the retaining rib 101f and the contacting portion 102f function to prevent the shaft-receiving member 101 from being engaged with the holding member 102 in a state in which the shaft-receiving member 101 is at a wrong position, and to prevent the shaft supporting portion 101A from being brought into pressure contact with the recess 102A by a method other than a pivoting operation of the shaft-receiving member 101.

That is, when the shaft-receiving member 101 is at the second position, the contacting portion 102f comes into contact with the shaft-receiving member 101 and functions as a restricting portion that restricts the engagement and disengagement or separation of the shaft supporting portion 101A with and from the recess 102A. When the shaft-receiving member 101 is at the first position, the contacting portion 102f does not come into contact with the shaft-receiving member 101 and allows the shaft supporting portion 101A to be engaged with and disengaged from the recess 102A.

As illustrated in FIG. 8, when the shaft-receiving member 101 is pivoted to the second position in a state in which the shaft supporting portion 101A has reached the reference position z0, the operation portion 101e of the shaft-receiving member 101 comes into contact with the locking portion 102g of the holding member 102, and the pivoting of the shaft-receiving member 101 in the pivoting direction R2 is restricted. The locking portion 102g functions as a stopper that restricts the shaft-receiving member 101 from pivoting beyond the second position in the pivoting direction R2 of the shaft-receiving member 101 from the first position toward the second position. The contacting portion 102f described above can have a function of the stopper.

Further, in a process in which the shaft-receiving member 101 is pivoted from the first position to the second position in a state in which the shaft supporting portion 101A has reached the reference position z0, the claw portion 101g of the shaft-receiving member 101 comes into contact with the locking portion 102g serving as a contact portion provided in the holding member 104. The claw portion 101g pressed by the locking portion 102g is temporarily retracted to the left in FIG. 8 by elastic deformation of the arm portion 101h, and then released from the locking portion 102g and moves to the right in FIG. 8 until the shaft-receiving member 101 reaches the second position. The contact and release of the claw portion 101g with respect to the locking portion 102g can provide a click feeling to the operator through the operation portion 101e. As a result, the operator can easily recognize that the shaft-receiving member 101 has been pivoted to a correct position, so that the workability can be further improved.

In addition, since the claw portion 101g is locked to the locking portion 102g, it is possible to prevent the shaft-receiving member 101 from inadvertently moving from the second position toward the first position when a finger of the operator comes into contact with the shaft-receiving member 101 after the shaft-receiving member 101 is pivoted from the first position to the second position. When removing the transfer roller unit 410 from the apparatus body 1A, it is sufficient if the operator pivots the shaft-receiving member 101 from the second position to the first position while pressing the operation portion 101e to disengage the claw portion 101g from the locking portion 102g.

In a case where there is play between the shaft-receiving member for the transfer roller provided in a unit attachable to and detachable from the apparatus body of the image forming apparatus and the holding member disposed in the apparatus body for holding the shaft-receiving member, the positioning accuracy for the transfer roller may be deteriorated. On the other hand, for example, with a configuration in which the shaft-receiving member is press-fitted into the holding member upon attaching the unit, workability of replacement may be deteriorated.

As described above, according to the present embodiment, the width of the outer peripheral surface of the shaft supporting portion 101A varies depending on a position in a circumferential direction with respect to the rotation axis Ax1, and L2 (second length) is larger than L1 (first length). Further, by pivoting the shaft-receiving member 101 after the shaft supporting portion 101A is engaged with the recess 102A, the outer peripheral surface of the shaft supporting portion 101A is brought into pressure contact with the inner surface of the recess 102A. In other words, in a case where the transfer roller unit 410 (detachable unit) is attached to the apparatus body 1A, the shaft supporting portion 101A is engaged with the recess 102A as the shaft-receiving member 101 at the first position is moved in the attaching direction D1 (first direction). Thereafter, the shaft-receiving member 101 is pivoted from the first position to the second position, and the shaft-receiving member 101 is held by the holding member 102 in a state in which the outer peripheral surface of the shaft supporting portion 101A comes into pressure contact with the inner surface of the recess 102A.

With such a configuration, it is possible to provide an image forming apparatus with improved positioning accuracy for a transfer roller without impairing workability of replacement.

### Modified Example

In the first embodiment, a configuration in which the width L1 of the shaft supporting portion 101A when the shaft-receiving member 101 is at the first position is smaller than the opening width Lw of the recess 102A has been described. In such a configuration, when the shaft supporting portion 101A is engaged with the recess 102A, the shaft supporting portion 101A passes through the opening 102e in a state in which there is a gap between the shaft supporting portion 101A and the inner surface of the recess 102A. The present technology is not limited thereto, and the shaft supporting portion 101A may pass through the opening 102e while rubbing with the inner surface of the recess 102A when the shaft supporting portion 101A is engaged with the recess 102A.

That is, the width L1 (first length) of the shaft supporting portion 101A in the width direction D2 (second direction) when the shaft-receiving member 101 is at the first position may be equal to or larger than the opening width Lw of the recess 102A (L1≥Lw). In this case, similarly to the first embodiment, the width L2 (second length) of the shaft supporting portion 101A in the width direction D2 (second direction) when the shaft-receiving member 101 is at the second position is larger than the width L3 (third length) of the recess 102A at the reference position z0. A difference between L2 (second length) and L3 (third length) is larger than a difference between L1 (first length) and Lw (the opening width of the recess) (L2−L3 >L1−Lw). With such a configuration, the pressure contact force acting between the shaft supporting portion 101A and the recess 102A in a state in which the shaft-receiving member 101 is pivoted to the second position after the shaft supporting portion 101A is engaged with the recess 102A becomes larger than a force acting between the shaft supporting portion 101A and the recess 102A when the shaft supporting portion 101A passes through the opening 102e. Therefore, similarly to the first embodiment, it is possible to provide an image forming apparatus with improved positioning accuracy for a transfer roller without impairing workability of replacement.

### Second Embodiment

Another embodiment (second embodiment) of the present disclosure will be described. Hereinafter, elements denoted by reference numerals common to the first embodiment will have basically the same configurations and actions as those described in the first embodiment unless otherwise specified, and portions different from those of the first embodiment will be mainly described.

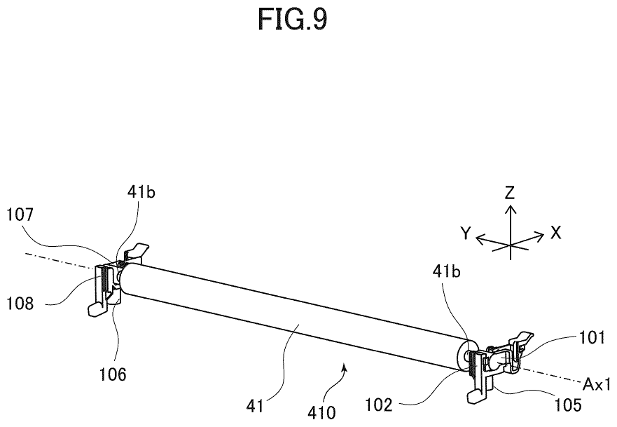

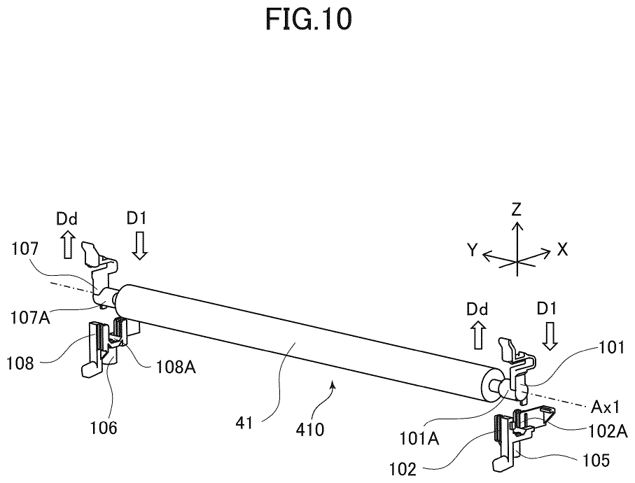

FIG. 9 is a perspective view of a transfer roller unit 410 in the second embodiment. FIG. 10 is a perspective view illustrating a state in which a replacement work for the transfer roller unit 410 is being performed in the second embodiment.

As illustrated in FIG. 9, the transfer roller unit 410 of the present embodiment includes a transfer roller 41, a shaft-receiving member 101 (first shaft-receiving member) that holds one end of a rotation shaft 41b of the transfer roller 41, and a shaft-receiving member 107 (second shaft-receiving member) that holds the other end of the rotation shaft 41b. As illustrated in FIG. 10, two shaft-receiving members 101 and 107 holding both ends of the rotation shaft 41b of the transfer roller 41 are configured to be attachable to and detachable from (replaceable with respect to) an apparatus body 1A together with the transfer roller 41. With such a configuration, the replacement work can be performed in a state in which both ends of the transfer roller 41 are axially supported by the shaft-receiving members 101 and 107, and thus, a possibility that the operator inadvertently touches a surface of the transfer roller 41 can be further reduced.

The shaft-receiving member 101 is engaged with a holding member 102 of the apparatus body 1A, and is held (supported) by the holding member 102. The shaft-receiving member 107 is engaged with a holding member 108 of the apparatus body 1A, and is held (supported) by the holding member 108.

Each of holding members 102 and 108 is configured to be slidable (linearly movable or reciprocally movable) in the Z-axis direction with respect to a frame body of the apparatus body 1A. Nip pressure springs 105 and 106 urge the holding members 102 and 108 upward, respectively. In a state in which both a process unit 50 and the transfer roller unit 410 are attached to the apparatus body 1A, the transfer roller 41 is pressed against a photosensitive drum 51 by urging forces of the nip pressure springs 105 and 106, and a transfer nip N1 is formed.

Configurations of the shaft-receiving member 107 and the holding member 108 may be substantially the same as the configurations of the shaft-receiving member 101 and the holding member 102 except that a member shape is reversed with respect to the Y-axis direction. In the case of attaching the transfer roller unit 410 of the present embodiment to the apparatus body 1A, the left and right shaft-receiving members 101 and 107 are simultaneously moved in an attaching direction D1 to engage shaft supporting portions 101A and 107A with recesses 102A and 108A of the holding members 102 and 108. Thereafter, each of the shaft-receiving members 101 and 107 is pivoted from a first position to a second position, and the attaching of the shaft-receiving members 101 and 107 to the holding members 102 and 108 is completed.

With such a configuration, similarly to the first embodiment, it is possible to provide an image forming apparatus with improved positioning accuracy for a transfer roller without impairing workability of replacement.

### Third Embodiment

Another embodiment (third embodiment) of the present disclosure will be described. Hereinafter, elements denoted by reference numerals common to the first embodiment will have basically the same configurations and actions as those described in the first embodiment unless otherwise specified, and portions different from those of the first embodiment will be mainly described.

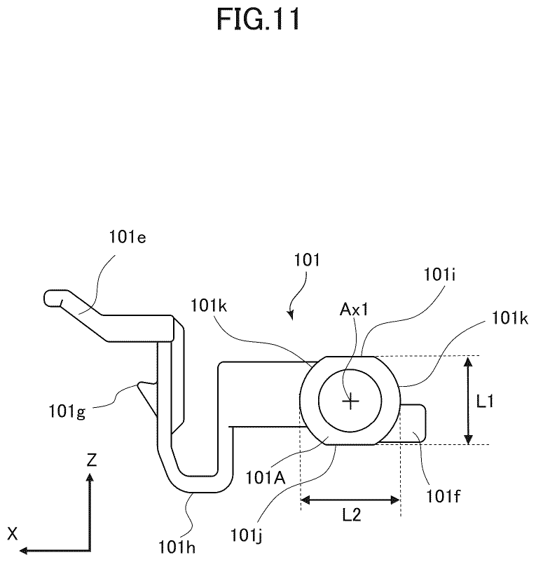

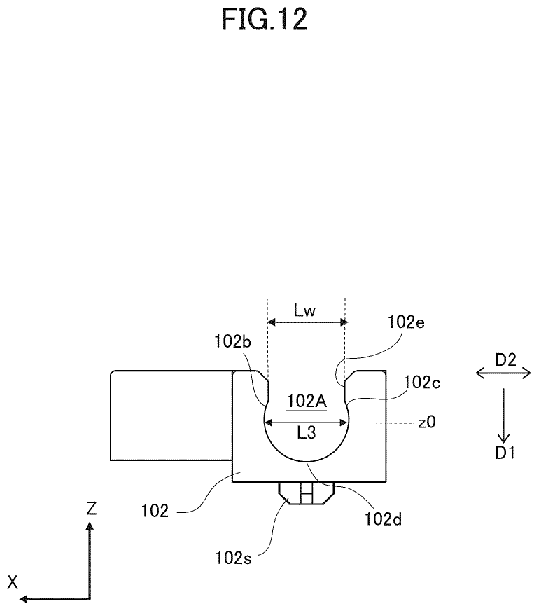

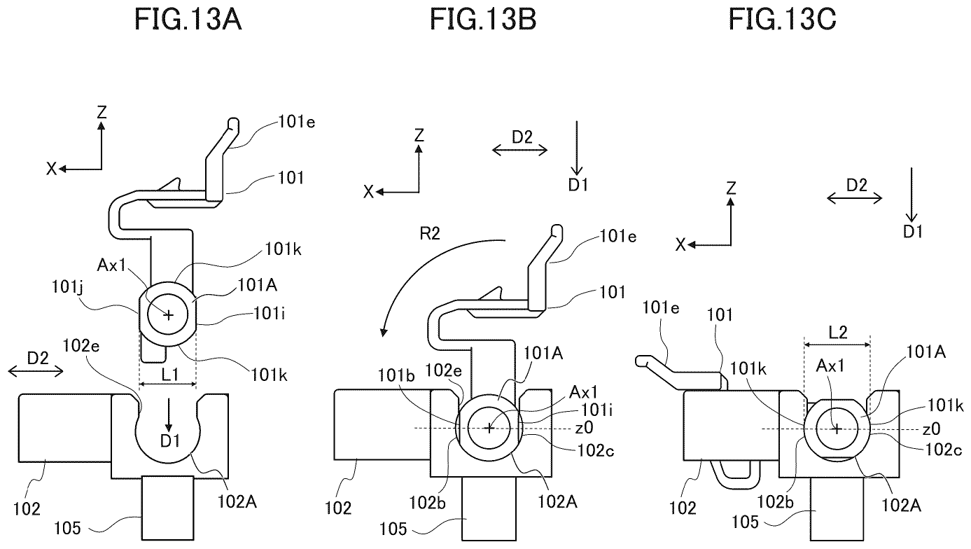

FIG. 11 is a side view of a shaft-receiving member 101 of the present embodiment as viewed in a direction (Y-axis direction) of a rotation axis Ax1 of a transfer roller 41. FIG. 12 is a side view of a holding member 102 of the present embodiment as viewed in the Y-axis direction. FIGS. 13A to 13C are views of the shaft-receiving member 101 and the holding member 102 of the present embodiment as viewed from the inside of an apparatus (a center side of the transfer roller 41) in a roller axial direction. FIG. 13A illustrates a state before the shaft-receiving member 101 is attached to the holding member 102. FIG. 13B illustrates a state in which the shaft-receiving member 101 is at a first position and a shaft supporting portion 101A is engaged with a recess 102A of the holding member 102. FIG. 13C illustrates a state in which the shaft-receiving member 101 is further pivoted from the first position to a second position.

As illustrated in FIG. 11, an outer peripheral surface of the shaft supporting portion 101A of the shaft-receiving member 101 in the present embodiment includes an arcuate portion 101k (cylindrical portion) and retraction portions 101i and 101j (flat portions). The arcuate portion 101k is formed in an arcuate shape (cylindrical surface shape) centered on the rotation axis Ax1 as viewed in the roller axis direction. The retraction portions 101i and 101j are retracted inward in a radial direction orthogonal to the rotation axis Ax1 as compared with an imaginary cylindrical surface in contact with the arcuate portion 101k.

In the present embodiment, the retraction portions 101i and 101j are provided at two positions opposite to each other across the rotation axis Ax1. However, the retraction portions 101i and 101j may be provided only on one side of the rotation axis Ax1. In the present embodiment, the retraction portions 101i and 101j have flat shapes parallel to the rotation axis Ax1 and parallel to each other. That is, the shaft supporting portion 101A in the present embodiment has an I-cut shape in which a circle is partially cut out by two straight lines parallel to each other as viewed in the roller axial direction.

The shaft-receiving member 101 is pivotable (movable) to the first position (FIGS. 13A and 13B) and the second position (FIG. 5A and FIG. 13C) around the rotation axis Ax1. As the shaft-receiving member 101 pivots, orientations of the retraction portions 101i and 101j are changed, and a width of the shaft supporting portion 101A in a width direction D2 of the recess 102A is changed.

A width of the outer peripheral surface of the shaft supporting portion 101A when the shaft-receiving member 101 is at the first position (a first phase or a first angle) is referred to as L1 (first length). A width of the outer peripheral surface of the shaft supporting portion 101A when the shaft-receiving member 101 is at the second position (a second phase or a second angle) is referred to as L2 (second length).

In the present embodiment, L2 is larger than L1 (L2>L1). In other words, the width of the outer peripheral surface of the shaft supporting portion 101A in the width direction D2 (second direction) when the shaft supporting portion 101A is engaged with the recess 102A in a state in which the shaft-receiving member 101 is at the first position is referred to as the first length (L1). The width of the outer peripheral surface of the shaft supporting portion 101A in the width direction D2 (second direction) when the shaft-receiving member 101 is pivoted from the first position to the second position (the second phase, the second angle, or an attaching posture) in a state in which the shaft supporting portion 101A is engaged with the recess 102A is referred to as the second length (L2). In this case, the first length is smaller than the second length.

Specifically, in the present embodiment, the retraction portions 101i and 101j are disposed such that the retraction portions 101i and 101j are directed to the width direction D2 when the shaft-receiving member 101 is at the first position, and the arcuate portion 101k is directed to the width direction D2 when the shaft-receiving member 101 is at the second position. Therefore, L1 in the present embodiment is equal to an interval between the retraction portions 101i and 101j. L2 in the present embodiment is a diameter of the arcuate portion 101k.

A configuration of a portion other than the shaft supporting portion 101A of the shaft-receiving member 101 may be the same as that of the shaft-receiving member 101 of the first embodiment.

As illustrated in FIG. 12, the recess 102A of the holding member 102 in the present embodiment is formed such that a width L3 (third length) of the recess 102A at a reference position z0 is larger than an opening width Lw of the recess 102A (L3>Lw). The recess 102A of the present embodiment is formed in an arcuate shape. The width L3 of the recess 102A at the reference position z0 is an inner diameter of the arcuate-shaped recess 102A. The center of the arc of the recess 102A coincides with the rotation axis Ax1 of the transfer roller 41 when the shaft-receiving member 101 is attached to the holding member 102.

As illustrated in FIG. 13A, in a case where the transfer roller unit 410 is attached to an apparatus body 1A, the shaft-receiving member 101 is moved in an attaching direction D1 in a state in which the shaft-receiving member 101 is at the first position. As a result, the shaft supporting portion 101A of the shaft-receiving member 101 passes through an opening 102e of the holding member 102 that is opened toward an upstream side in the attaching direction D1 and is engaged with the recess 102A.

Here, the width L1 of the shaft supporting portion 101A when the shaft-receiving member 101 is at the first position is smaller than the opening width Lw of the recess 102A (L1<Lw). In other words, in a state in which the transfer roller unit 410 (detachable unit) is not attached to the apparatus body 1A, a minimum value of the width of the recess 102A in the width direction D2 (second direction) within an area upstream of the reference position z0 in the attaching direction D1 (first direction) is referred to as the opening width Lw of the recess 102A. In this case, the first length (L1) is smaller than the opening width Lw of the recess 102A.

Therefore, the shaft supporting portion 101A is received in the recess 102A without receiving a frictional resistance from an inner surface of the recess 102A. Specifically, the shaft supporting portion 101A passes through the opening 102e of the recess 102A and is inserted into the recess 102A in a state in which there is a gap between the retraction portions 101i and 101j of the shaft supporting portion 101A and side surfaces 102c and 102b of the recess 102A. When the outer peripheral surface of the shaft supporting portion 101A comes into contact with a bottom surface 102d of the recess 102A, the shaft supporting portion 101A reaches the reference position z0.

As illustrated in FIG. 13B, in a state in which the shaft supporting portion 101A has reached the reference position z0, an operator operates an operation portion 101e to pivot the shaft-receiving member 101 in a pivoting direction R2 from the first position to the second position. Then, the arcuate portion 101k of the outer peripheral surface of the shaft supporting portion 101A faces the side surfaces 102c and 102b of the recess 102A. When the shaft-receiving member 101 is pivoted from the first position to the second position in a state in which the shaft supporting portion 101A is at the reference position z0, the attaching of the shaft-receiving member 101 to the holding member 102 is completed.

Here, the width L2 of the shaft supporting portion 101A when the shaft-receiving member 101 is at the second position is larger than the width L3 of the recess 102A at the reference position z0 (L2>L3). Therefore, as the shaft-receiving member 101 is pivoted to the second position, a part (arcuate portion 101k) of the outer peripheral surface of the shaft supporting portion 101A comes into pressure contact with the inner surface of the recess 102A (press-fitted state). As a result, the movement of the shaft supporting portion 101A in the width direction D2 is restricted, and a rotation axis of the transfer roller 41 is positioned in the width direction D2.

As described above, the outer peripheral surface of the shaft supporting portion 101A comes into pressure contact with the inner surface of the recess 102A, so that play of the shaft-receiving member 101 can be suppressed, and deterioration in positioning accuracy for the transfer roller 41 can be suppressed.

That is, with the configuration of the present embodiment, it is also possible to provide an image forming apparatus with improved positioning accuracy for a transfer roller without impairing workability of replacement.

In the present embodiment, the opening width Lw of the recess 102A is smaller than the width L3 (third length) of the recess 102A at the reference position z0 (L3>Lw). Therefore, there is an advantage that a possibility that the shaft supporting portion 101A is separated from the recess 102A in a state in which the shaft-receiving member 101 is at the second position can be reduced.

### Modified Example

In the third embodiment, a configuration in which L1 <Lw has been described. The present technology is not limited thereto, and similarly to the description of the modified example of the first embodiment, the width L1 (first length) of the shaft supporting portion 101A in the width direction D2 (second direction) when the shaft-receiving member 101 is at the first position may be set to be equal to or larger than the opening width Lw of the recess 102A (L1≥Lw). In this case, the width L2 (second length) of the shaft supporting portion 101A in the width direction D2 (second direction) when the shaft-receiving member 101 is at the second position is larger than the width L3 (third length) of the recess 102A at the reference position z0. A difference between L2 (second length) and L3 (third length) is larger than a difference between L1 (first length) and Lw (the opening width of the recess) (L2−L3 >L1−Lw). With such a configuration, a pressure contact force acting between the shaft supporting portion 101A and the recess 102A in a state in which the shaft-receiving member 101 is pivoted to the second position after the shaft supporting portion 101A is engaged with the recess 102A becomes larger than a force acting between the shaft supporting portion 101A and the recess 102A when the shaft supporting portion 101A passes through the opening 102e. Therefore, similarly to the third embodiment, it is possible to provide an image forming apparatus with improved positioning accuracy for a transfer roller without impairing workability of replacement.

### Other Modifications

The technology of the present disclosure is not limited to the embodiments described above. For example, in the third embodiment, the shaft supporting portion 101A has the I-cut shape. However, the shaft supporting portion 101A may also have a shape (D-cut shape) in which only one of the retraction portions 101i and 101j is provided and the remaining portion of the outer peripheral surface of the shaft supporting portion 101A is the arcuate portion 101k.

Furthermore, in the first to third embodiments, a direct transfer type monochrome laser beam printer has been exemplified as the image forming apparatus. However, the image forming apparatus may also be, for example, an intermediate transfer type color laser beam printer. The intermediate transfer type is a type in which a toner image formed on a photosensitive drum is primarily transferred to an intermediate transfer member such as an intermediate transfer belt, and then the toner image is transferred from the intermediate transfer member to a recording material. In this case, the “transfer roller” may be a secondary transfer roller that forms a transfer portion (secondary transfer nip) with the intermediate transfer member serving as an image bearing member.

According to the present disclosure, it is possible to provide an image forming apparatus with improved positioning accuracy for a transfer roller without impairing workability of replacement.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-144379, filed Aug. 26, 2024, which is hereby incorporated by reference herein in its entirety.

What is claimed is:

1. An image forming apparatus comprising:
an apparatus body including an image bearing member; and
a detachable unit detachably attached to the apparatus body, the detachable unit including
(i) a transfer roller including a roller shaft configured to rotate around a rotation axis, the transfer roller being configured to form a transfer portion, at which an image is transferred from the image bearing member to a recording material, together with the image bearing member, and
(ii) a pivoting member including a shaft supporting portion supporting the roller shaft rotatably, the pivoting member being pivotable between a first position and a second position around the rotation axis in a state in which the detachable unit is attached to the apparatus body,
wherein the apparatus body includes a holding member configured to hold the pivoting member and including a recess recessed in a first direction intersecting the rotation axis,
wherein in a case where the detachable unit is attached to the apparatus body, the shaft supporting portion is allowed to enter the recess by moving the pivoting member in the first direction while maintaining the pivoting member in a posture corresponding to a posture of the pivoting member when the pivoting member attached to the apparatus body is at the first position,
wherein the holding member is configured to hold the shaft supporting portion in a state in which the pivoting member attached to the apparatus body is pivoted to the second position and an outer peripheral surface of the shaft supporting portion comes into pressure contact with an inner surface of the recess, and
wherein a first length is smaller than a second length, the first length being a width of the outer peripheral surface of the shaft supporting portion in a second direction orthogonal to the first direction in a case where the pivoting member at the first position is viewed in a direction of the rotation axis, the second length being a width of the outer peripheral surface in the second direction in a case where the pivoting member at the second position is viewed in the direction of the rotation axis.

2. The image forming apparatus according to claim 1,
wherein in a case where a position in the recess with respect to the first direction where the rotation axis is positioned in a state in which the detachable unit is attached to the apparatus body is referred to as a reference position, and a minimum value of a width of the recess in the second direction within an area upstream of the reference position in the first direction in a state in which the detachable unit is not attached to the apparatus body is referred to as an opening width of the recess,
the first length is smaller than the opening width.

3. The image forming apparatus according to claim 1,
wherein in a case where a position in the recess with respect to the first direction where the rotation axis is positioned in a state in which the detachable unit is attached to the apparatus body is referred to as a reference position, a width of the recess in the second direction at the reference position in a state in which the detachable unit is not attached to the apparatus body is referred to as a third length, and a minimum value of a width of the recess in the second direction within an area upstream of the reference position in the first direction is referred to as an opening width of the recess,
the first length is equal to or larger than the opening width,
the second length is larger than the third length, and
a difference between the second length and the third length is larger than a difference between the first length and the opening width.

4. The image forming apparatus according to claim 1,
wherein in a case where a position in the recess with respect to the first direction where the rotation axis is positioned in a state in which the detachable unit is attached to the apparatus body is referred to as a reference position, a width of the recess in the second direction at the reference position in a state in which the detachable unit is not attached to the apparatus body is referred to as a third length, and a minimum value of a width of the recess in the second direction within an area upstream of the reference position in the first direction is referred to as an opening width of the recess,
the opening width is smaller than the third length.

5. The image forming apparatus according to claim 1,
wherein the outer peripheral surface of the shaft supporting portion includes an arcuate portion formed in an arcuate shape centered on the rotation axis as viewed in the direction of the rotation axis, and a protrusion protruding outward from the arcuate portion in a radial direction orthogonal to the rotation axis,
wherein the arcuate portion is directed to the second direction in a case where the pivoting member is at the first position, and
wherein the protrusion are directed to the second direction in a case where the pivoting member is at the second position.

6. The image forming apparatus according to claim 5,
wherein the protrusion is provided at two positions opposite to each other across the rotation axis.

7. The image forming apparatus according to claim 1,
wherein the outer peripheral surface of the shaft supporting portion includes an arcuate portion formed in an arcuate shape centered on the rotation axis as viewed in the direction of the rotation axis, and a retraction portion retracted inward from the arcuate portion in a radial direction orthogonal to the rotation axis,
wherein the retraction portion are directed to the second direction in a case where the pivoting member is at the first position, and
wherein the arcuate portion is directed to the second direction in a case where the pivoting member is at the second position.

8. The image forming apparatus according to claim 7,
wherein the retraction portion is provided at two positions opposite to each other across the rotation axis.

9. The image forming apparatus according to claim 7,
wherein the retraction portion is formed in a flat shape parallel to the rotation axis.

10. The image forming apparatus according to claim 1,
wherein the holding member is elastically deformable such that a deformation amount of the outer peripheral surface of the shaft supporting portion due to engagement with the recess is smaller than a deformation amount of the inner surface of the recess due to engagement with the shaft supporting portion.

11. The image forming apparatus according to claim 1,
wherein the pivoting member includes an operation portion configured to be operated to pivot the pivoting member from the first position to the second position.

12. The image forming apparatus according to claim 11,
wherein the pivoting member includes an arm portion configured to be elastically deformed and a claw portion supported by the arm portion, and
wherein the holding member includes a contact portion configured to come into contact with the claw portion and allow passage of the claw portion by elastic deformation of the arm portion in a process in which the pivoting member is pivoted from the first position to the second position by an operation of the operation portion.

13. The image forming apparatus according to claim 1,
wherein the holding member includes a stopper configured to restrict the pivoting member from pivoting beyond the second position in a pivoting direction of the pivoting member from the first position toward the second position.

14. The image forming apparatus according to claim 1,
wherein the holding member includes a restricting portion configured to come into contact with the pivoting member to restrict separation of the shaft supporting portion from the recess in a case where the pivoting member is at the second position.

15. The image forming apparatus according to claim 1,
wherein in a case where the pivoting member at the second position is viewed in the direction of the rotation axis, a region where the outer peripheral surface of the shaft supporting portion and the inner surface of the recess come into contact with each other intersects an imaginary straight line that passes through the rotation axis and extends in a conveyance direction of the recording material at the transfer portion.

16. The image forming apparatus according to claim 1, further comprising:
an urging member configured to urge the transfer roller toward the image bearing member,
wherein the recess is opened in an urging direction of the urging member.

17. The image forming apparatus according to claim 1, further comprising:
an urging member configured to urge the holding member,
wherein the holding member is movable in the first direction and configured to receive an urging force of the urging member and transmit the urging force to the transfer roller to bring the transfer roller into contact with the image bearing member.
